(19) United States
(12) Patent Application Publication
(10) Pub. No.: US 2026/0161587 A1
(43) Pub. Date: Jun. 11, 2026

(54) IMAGE PROCESSING DEVICE AND CONTROL METHOD OF IMAGE PROCESSING DEVICE

(71) Applicant: Sigmastar Technology Ltd., Xiamen (CN)

(72) Inventor: Xiao Ding Zhu, Shanghai (CN)

(21) Appl. No.: 19/271,063

(22) Filed: Jul. 16, 2025

(30) Foreign Application Priority Data
Jul. 30, 2024 (CN) 202411034934.7

(51) Int. Cl. G06F 13/28

(52) U.S. Cl. CPC G06F 13/28; G06F 2213/28

(57) ABSTRACT

An image processing device processes a frame using two buffer circuits and two direct memory access (DMA) circuits. The first buffer circuit comprises M buffer blocks, while the second contains W tiles. The DMA circuits operate in one of two modes. In the first mode, the first DMA writes a first pixel line into one of the M buffer blocks, and the second DMA reads N pixels from each buffer block, combining them to produce M×N pixels that are then written into one of the W tiles. In the second mode, the first DMA writes a second pixel line across the M buffer blocks, each block holding a segment of the line, and the second DMA reads M×N pixels from one buffer block and writes them into one of the W tiles. Once M lines have been written into the buffer blocks, the first DMA switches operation mode.

This application claims the benefit of China application Serial No. CN202411034934.7, filed on Jul. 30, 2024, the subject matter of which is incorporated herein by reference.

### BACKGROUND OF THE INVENTION

### 1. Field of the Invention

The present invention generally relates to image processing, and more particularly, to an image processing device and a control method thereof.

### 2. Description of Related Art

Reference is made to FIG. 1, which is a schematic diagram of the conventional ping-pong buffering used for image processing. The height and width of the frame 100 are Ht and Wd, respectively (both Ht and Wd are integers greater than 1). The frame 100 contains Ht pixel lines (LN_1, LN_2, . . . , LN_i, . . . , 1≤i≤Ht), and a pixel line LN_i contains Wd pixels. The ping-pong buffering includes a buffer circuit 110 and a buffer circuit 120. The buffer circuit 110 and the buffer circuit 120 can each store Wd*M pixels. In other words, the buffer circuit 110 and the buffer circuit 120 can each simultaneously store up to M pixel line(s) of the frame 100 (M<Ht).

When a preceding image processing circuit writes image data to the buffer circuit 110 in a line (LN)-based manner, a subsequent image processing circuit reads the image data from the buffer circuit 120 in a tile (TL)-based manner. When the image data in the buffer circuit 110 and the image data in the buffer circuit 120 are both completely read, the buffer circuit 110 and the buffer circuit 120 swap their roles, forming the ping-pong buffering.

However, because the ping-pong buffering requires two buffer circuits, the cost of image processing increases.

### SUMMARY OF THE INVENTION

In view of the issues of the prior art, an object of the present invention is to provide an image processing device and a control method thereof, so as to make an improvement to the prior art.

According to one aspect of the present invention, an image processing device is provided. The image processing device is configured to process a frame and includes: a first buffer circuit including M buffer blocks, where M is an integer greater than 1; a second buffer circuit including W tiles, where W is an integer greater than 1; a first direct memory access (DMA) circuit coupled to the first buffer circuit and operating in a first mode or a second mode; and a second DMA circuit coupled to the first buffer circuit and the second buffer circuit and operating in the first mode or the second mode. In the first mode, the first DMA circuit writes a first pixel line of the frame into one of the M buffer blocks, and the second DMA circuit reads N pixels from each of the M buffer blocks and writes the M*N pixels into one of the W tiles, where N is an integer greater than 1. In the second mode, the first DMA circuit writes a second pixel line of the frame into the M buffer blocks, with each buffer block containing a portion of the second pixel line, and the second DMA circuit reads M*N pixels from one of the M buffer blocks and writes the M*N pixels into one of the W tiles. After the first DMA circuit writes M pixel lines into the M buffer blocks, the first DMA circuit switches modes.

According to another aspect of the present invention, a control method of an image processing device is provided. The image processing device is configured to process a frame and includes a first buffer circuit, a second buffer circuit, a first direct memory access (DMA) circuit, and a second DMA circuit. The first buffer circuit includes M buffer blocks, where M is an integer greater than 1. The second buffer circuit includes W tiles, where W is an integer greater than 1. The first DMA circuit operates in a first mode or a second mode and generates a first piece of current access progress information. The second DMA circuit operates in the first mode or the second mode and generates a second piece of current access progress information. The control method includes the following steps: controlling the second DMA circuit to switch modes when the first piece of current access progress information meets a first condition; or controlling the first DMA circuit to switch modes when the second piece of current access progress information meets a second condition. In the first mode, the first DMA circuit writes a first pixel line of the frame into one of the M buffer blocks, and the second DMA circuit reads N pixels from each of the M buffer blocks and writes the M*N pixels into one of the W tiles, where N is an integer greater than 1. In the second mode, the first DMA circuit writes a second pixel line of the frame into the M buffer blocks, with each buffer block containing a portion of the second pixel line, and the second DMA circuit reads M*N pixels from one of the M buffer blocks and writes the M*N pixels into one of the W tiles.

The technical means embodied in the embodiments of the present invention can solve at least one of the problems of the prior art. Therefore, compared to the prior art, the present invention can reduce costs.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a schematic diagram of a conventional ping-pong buffering used for image processing.

FIG. 2 is a functional block diagram of the image processing device according to an embodiment of the present invention.

FIG. 3 is a schematic diagram of the buffer circuit 240 and the buffer circuit 250 according to an embodiment of the present invention.

FIG. 4 is a flowchart of the control method of the image processing device according to an embodiment of the present invention.

FIG. 5 is the flowchart of the DMA 222 operating in the first mode.

FIG. 6 is a schematic diagram of the buffer circuit 240 after the DMA 222 writes M pixel lines into the buffer circuit 240.

FIG. 7 is a flowchart of the DMA 260 operating in the first mode.

FIG. 8 is a schematic diagram of the first time the buffer circuit 250 is filled by the DMA 260 in the first mode.

FIG. 9 is the flowchart of the DMA 222 operating in the second mode.

FIG. 10 is a schematic diagram of the buffer circuit 240 after the DMA 222 has completed one round of the process in FIG. 9 according to the present invention.

FIG. 11 is a schematic diagram of the buffer circuit 240 after the DMA 222 has completed the process of FIG. 9 according to the present invention.

FIG. 12 is the flowchart of the DMA 260 operating in the second mode.

FIG. 13 is a schematic diagram of the contents of the buffer circuit 240 and the buffer circuit 250 when the DMA 260 operates in the second mode according to the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an image processing device and a control method thereof. On account of that some or all elements of the image processing device could be known, the detail of such elements is omitted provided that such detail has little to do with the features of this disclosure, and that this omission nowhere dissatisfies the specification and enablement requirements. Some or all of the processes of the control method of an image processing device may be implemented by software and/or firmware and can be performed by the image processing device or its equivalent. A person having ordinary skill in the art can choose components or steps equivalent to those described in this specification to carry out the present invention, which means that the scope of this invention is not limited to the embodiments in the specification.

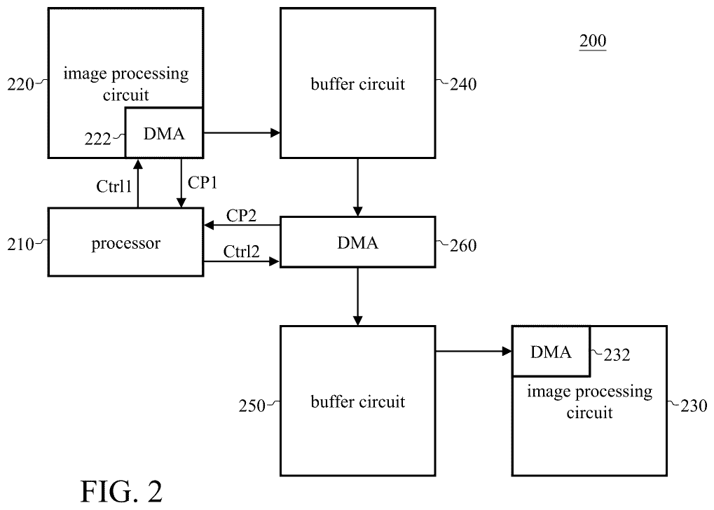

Reference is made to FIG. 2, which is a functional block diagram of the image processing device according to an embodiment of the present invention. The image processing device 200 includes a processor 210, an image processing circuit 220, an image processing circuit 230, a buffer circuit 240, a buffer circuit 250, and a direct memory access (DMA) 260. The image processing circuit 220 includes the DMA 222. The image processing circuit 230 includes the DMA 232. The buffer circuit 240 may be a Static Random Access Memory (SRAM) or a Dynamic Random Access Memory (DRAM), and the buffer circuit 250 may be an SRAM.

The processor 210 may be a circuit or electronic component with program execution capability, such as a central processing unit, a microprocessor, a microprocessing unit, a digital signal processor (DSP), an application-specific integrated circuit (ASIC), or an equivalent circuit.

The image processing circuit 220 writes the image data into the buffer circuit 240 through the DMA 222. The DMA 260 is used to read image data from the buffer circuit 240, and write the image data into the buffer circuit 250. The image processing circuit 230 reads image data from the buffer circuit 250 through the DMA 232.

The DMA 222 and the DMA 260 operate in a first mode or a second mode. The processor 210 controls the DMA 222 through the control signal Ctrl1 and controls the DMA 260 through the control signal Ctrl2. The DMA 222 and the DMA 260 respectively transmit a piece of current access progress information CP1 and a piece of current access progress information CP2 to the processor 210.

In some embodiments (for illustrative purposes only, not to limit the scope of the present invention), the image processing circuit 220 may be an image scaler, and the image processing circuit 230 may be a Joint Photographic Experts Group (JPEG) encoder.

In the following discussion, it is assumed that the minimum code unit of the image processing circuit 230 is M (rows)*N (pixels). In other words, the image processing circuit 230 performs image encoding in units of a tile TL, and the size of the tile TL is M*N pixels. M and N are both integers greater than 1. In some embodiments, M is equal to N.

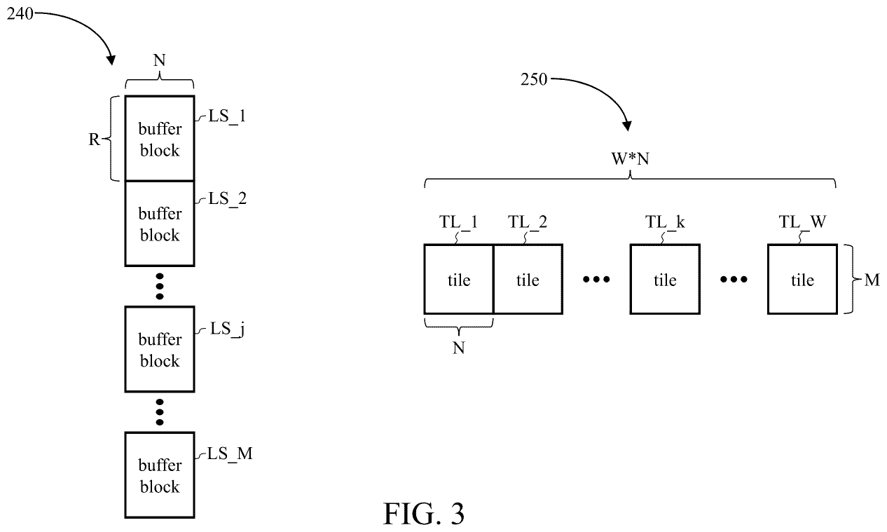

Reference is made to FIG. 3, which is a schematic diagram of the buffer circuit 240 and the buffer circuit 250 according to an embodiment of the present invention. The buffer circuit 240 includes M buffer blocks (LS_1, LS_2, . . . , LS_j, . . . , and LS_M, where 1≤j≤M). The size of each buffer block is R (row)*N (pixels). The buffer circuit 250 includes W tiles TL (TL_1, TL_2, . . . , TL_k, . . . , and TL_W, where W is an integer greater than 1, and 1≤k≤W). The size of each tile TL is M (rows)*N (pixels). Therefore, the width of the buffer circuit 250 is W*N, meaning that a row contains W*N pixels.

In the first mode, a buffer block stores an entire pixel line of the frame 100. In the second mode, a buffer block stores W*N pixels of a pixel line, but stores M consecutive lines of the frame 100 (i.e., a total of M*W*N pixels are stored). The number of rows R of a buffer block is as shown in Equation (1) (where Wd is the width of the frame 100). For example, when Wd=1920 and N=M=16, R=128. For another example, when Wd=3840 and N=M=16, R=256.

$$R = ( Wd + N * M - 1 ) / ( N * M ) \qquad ( 1 )$$

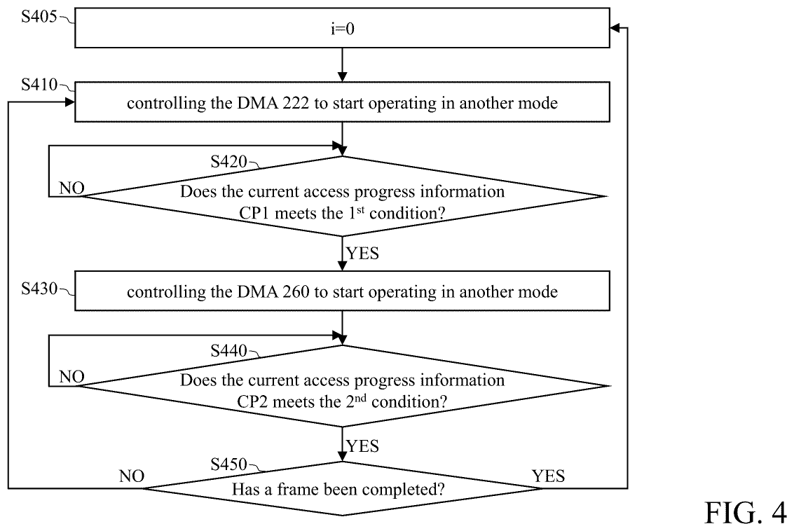

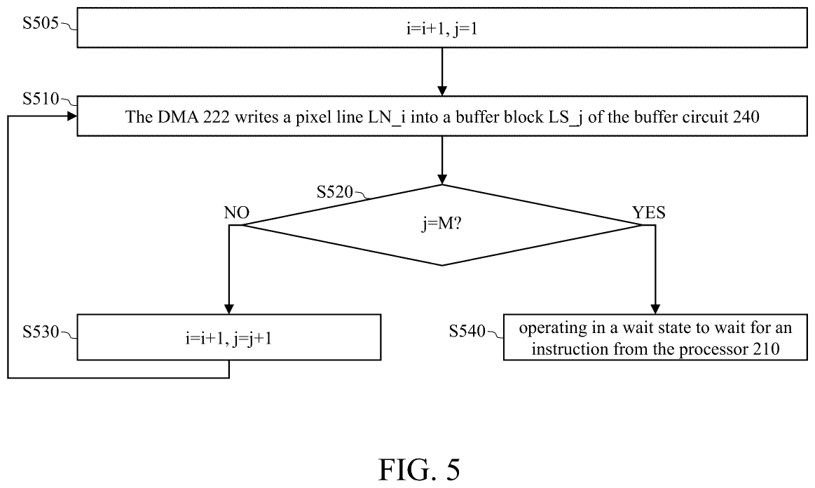

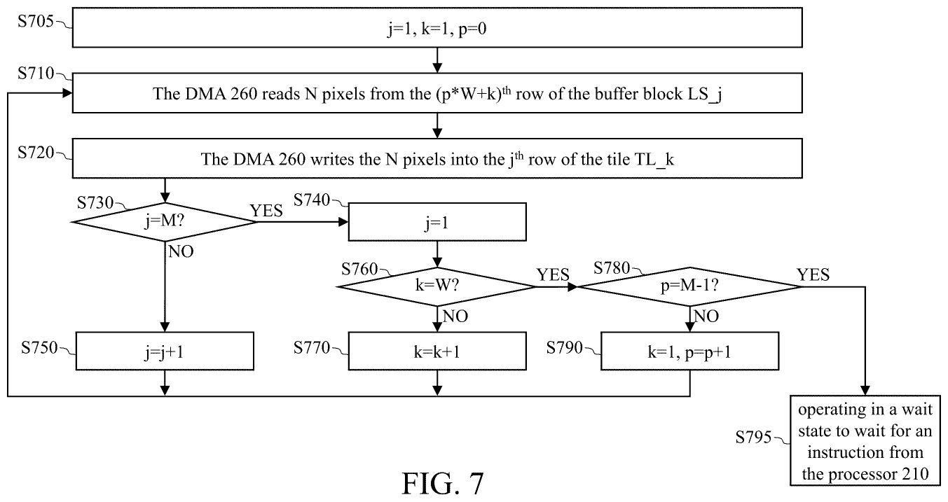

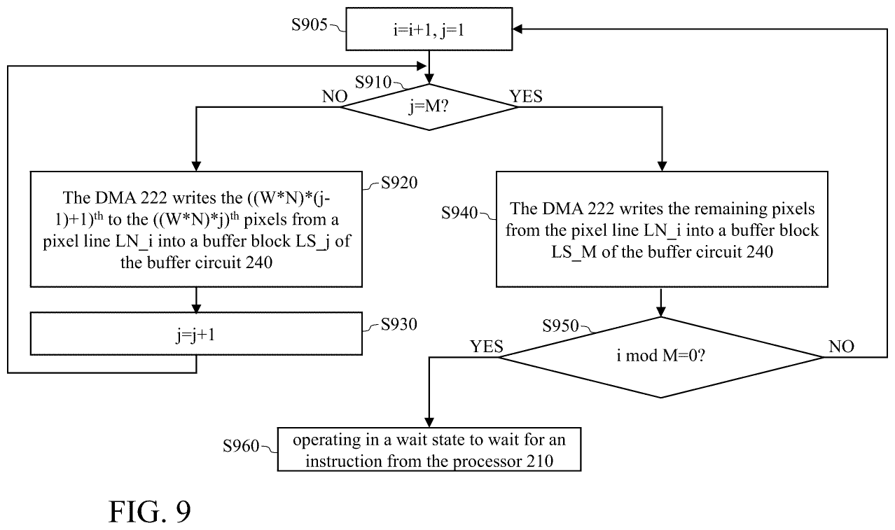

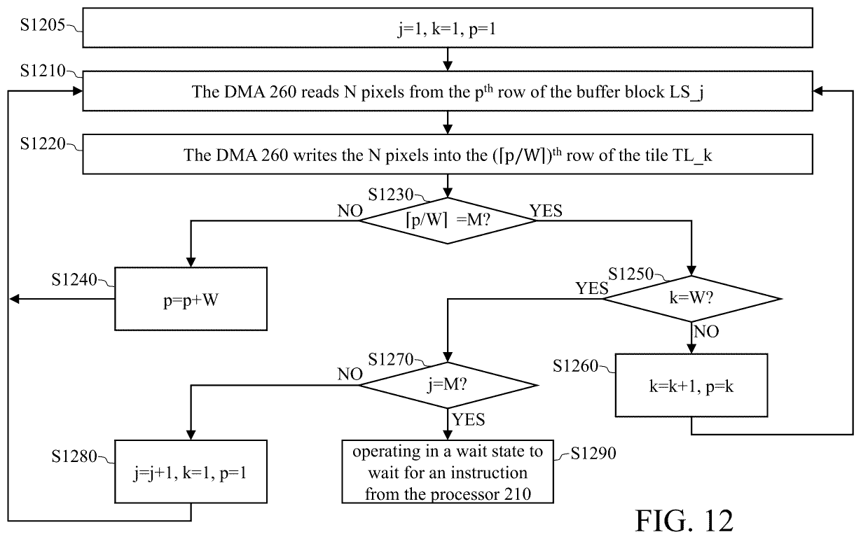

Reference is made to FIG. 4, which is a flowchart of the control method of the image processing device according to an embodiment of the present invention. The flowchart includes the following steps.
Step S405: The processor 210 initializes the variable i to 0. The variable i will be used in the operation process of the DMA 222 and will be detailed below with reference to FIG. 5 and FIG. 9.
Step S410: The processor 210 controls the DMA 222 through the control signal Ctrl1 to start operating in another mode (i.e., switch modes). More specifically, if the DMA 222 previously operated in the first mode (FIG. 5) (or the second mode (FIG. 9)), then after step S410, the DMA 222 switches to operate in the second mode (or the first mode). In other words, the DMA 222 alternately operates in the first mode and the second mode. In some embodiments, the first operation mode of the DMA 222 after the image processing device 200 is activated is the first mode.
Step S420: The processor 210 determines whether the progress of the DMA 222 meets a first condition. If YES, then the flow proceeds to step S430; otherwise, the processor 210 continuously monitors the progress of the DMA 222 (step S420). During the process of accessing the buffer circuit, the DMA 222 continuously informs the processor 210 of the piece of current access progress information CP1. In some embodiments, the piece of current access progress information CP1 may be the write index by which the DMA 222 accesses the buffer circuit 240.
Step S430: The processor 210 controls the DMA 260 through the control signal Ctrl2 to start operating in another mode (i.e., switch modes). More specifically, if the DMA 260 previously operated in the first mode (FIG. 7) (or the second mode (FIG. 12)), then after step S430, the DMA 260 switches to operate in the second mode (or the first mode). In other words, the DMA 260 alternately operates in the first mode and the second mode. In some embodiments, the first operation mode of the DMA 260 after the image processing device 200 is activated is the first mode.
Step S440: The processor 210 determines whether the progress of the DMA 260 meets a second condition. If YES, then the flow proceeds to step S450; otherwise, the processor 210 continuously monitors the progress of the DMA 260 (step S440). During the process of accessing the buffer circuit, the DMA 260 continuously informs the processor 210 of the piece of current access progress information CP2. In some embodiments, the piece of current access progress information CP2 may be the read index by which the DMA 260 accesses the buffer circuit 240 and/or the write index by which the DMA 260 accesses the buffer circuit 250.
Step S450: The processor 210 determines whether the writing and reading of a frame have been completed. If YES, then the flow proceeds to step S405 (in which the variable i is reset to 0); otherwise, the flow proceeds to step S410.

The following explains the operational details of the DMA 222 and the DMA 260 for the first mode (FIGS. 5 to 8) and the second mode (FIGS. 9 to 13), respectively. The piece of current access progress information CP1, the piece of current access progress information CP2, the first condition, and the second condition will be illustrated below.

### The First Mode

Reference is made to FIG. 5, which is a flowchart of the DMA 222 operating in the first mode. The flowchart includes the following steps.
Step S505: The DMA 222 updates the variable i to i+1 and sets the variable j to 1.
Step S510: The DMA 222 writes a pixel line LN_i into a buffer block LS_j of the buffer circuit 240. In this step, the DMA 222 continuously writes the pixel line into the same buffer block.
Step S520: The DMA 222 determines whether the variable j is equal to M. If YES, then the flow proceeds to step S540; otherwise, the flow proceeds to step S530.
Step S530: The DMA 222 updates the variable i to i+1 and the variable j to j+1.
Step S540: The DMA 222 waits for an instruction from the processor 210. More specifically, the DMA 222 operates in a wait state (in which the operation is suspended) until the processor 210 controls it to exit the wait state and operate in the second mode (FIG. 9). In other words, the DMA 222 is about to switch modes when it operates in the wait state.

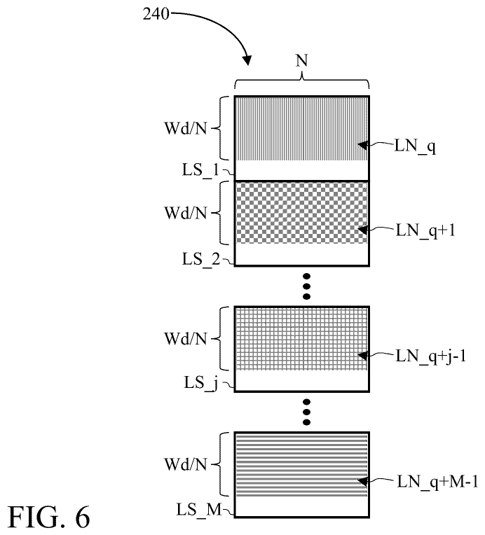

Reference is made to FIG. 6, which is a schematic diagram of the buffer circuit 240 after the DMA 222 has written M pixel lines into the buffer circuit 240. In the process of FIG. 5, the DMA 222 sequentially writes the q^{th} pixel line LN_q, the (q+1)^{th} pixel line LN_q+1, the (q+j−1)^{th} pixel line LN_q+j−1, and the (q+M−1)^{th} pixel line LN_q+M−1 of the frame 100 into the buffer block LS_1, the buffer block LS_2, the buffer block LS_j, and the buffer block LS_M, respectively. In other words, the write stride of the DMA 222 is the size of a buffer block (i.e., W*M*N pixels). When the variable j equals M (i.e., when the image processing circuit 220 completes the first mode) (the result of step S520 is YES), the buffer block LS_1 to the buffer block LS_M respectively store the q^{th} pixel line to the (q+M−1)^{th} pixel line of the frame 100 (each pixel line is stored in the first row to the (Wd/N)^{th} row of each buffer block, where Wd/N≤R) (q=r*M+1, r=0, 1, 2, . . . , and q≤Ht).

Reference is made to FIG. 7, which is a flowchart of the DMA 260 operating in the first mode. The flowchart includes the following steps.
Step S705: The DMA 260 sets the variables j and k to 1 and the variable p to 0.
Step S710: The DMA 260 reads N pixels from the (p*W+k)^{th} row of the buffer block LS_j.
Step S720: The DMA 260 writes the N pixels into the j^{th} row of the tile TL_k.
Step S730: The DMA 260 determines whether the variable j is equal to M. If YES (meaning that the DMA 260 has written the (p*W+k)^{th} row from each of the M buffer blocks into the tile TL_k, also meaning that the tile TL_k has been filled), then the flow proceeds to step S740; otherwise, the flow proceeds to step S750.
Step S740: The DMA 260 resets the variable j to 1.
Step S750: The DMA 260 updates the variable j to j+1.
Step S760: The DMA 260 determines whether the variable k is equal to W. If YES (meaning that the W^{th} tile TL_W of the buffer circuit 250 has been filled, that is, the DMA 260 has filled the entire buffer circuit 250), then the flow proceeds to step S780; otherwise, the flow proceeds to step S770.
Step S770: The DMA 260 updates the variable k to k+1, so that the DMA 260 subsequently reads the next row of the buffer block LS_j in step S710 and writes it into the next tile in step S720.
Step S780: The DMA 260 determines whether the variable p is equal to M−1. If YES (meaning that the DMA 260 has finished reading all the buffer blocks (LS_1 to LS_M) of the buffer circuit 240), then the flow proceeds to step S795; otherwise, the flow proceeds to step S790.
Step S790: The DMA 260 resets the variable k to 1 and updates the variable p to p+1.
Step S795: The DMA 260 waits for an instruction from the processor 210. More specifically, the DMA 260 operates in a wait state (in which the operation is suspended) until the processor 210 controls it to exit the wait state and operate in the second mode (FIG. 12). In other words, the DMA 260 is about to switch modes when it operates in the wait state.

It is known from FIG. 7 that because the variable j increases by 1 in each iteration of step S750, the read offset of the DMA 260 is the size of one buffer block (W*M*N pixels) (step S710), and the write stride of the DMA 260 is one row of the buffer circuit 250 (W*N pixels) (step S720).

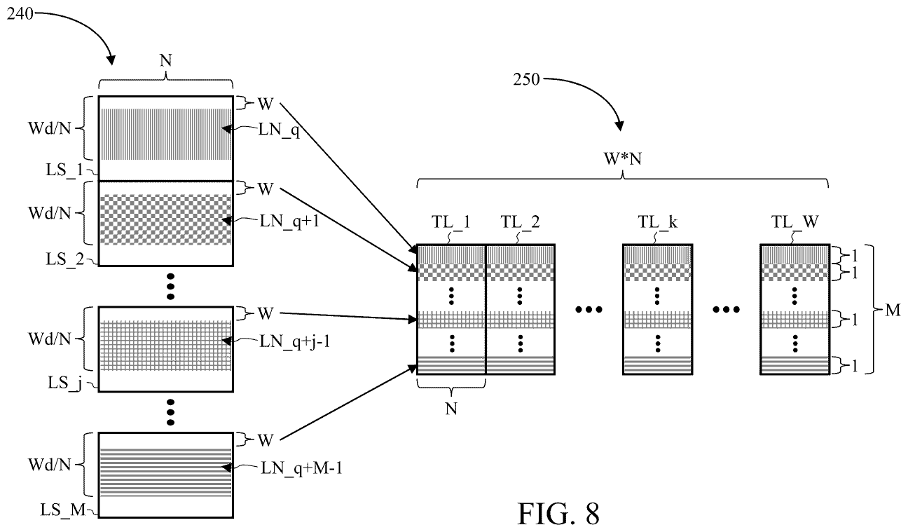

Reference is made to FIG. 8, which is a schematic diagram of the first time the buffer circuit 250 is filled by the DMA 260 in the first mode (the result of step S760 is YES). For the buffer circuit 240, the pixels from W rows (a total of W*N pixels) of each buffer block have been read, which means that there is a temporary space of W*N pixels in each buffer block available for writing image data. For the buffer circuit 250, each tile stores M rows of pixels, and the M rows of pixels come from M buffer blocks (LS_1 to LS_M) of the buffer circuit 240, respectively. That is to say, the W*N pixels of the buffer block LS_j have been written to the j^{th} row of the buffer circuit 250 (a total of W*N pixels, spanning W tiles). It should be noted that the temporary spaces in the M buffer blocks (a total of W*M*N pixels) are exactly equal to the storage space of a buffer block.

In some embodiments, when the tile TL_1 is filled, the DMA 232 can start reading the tile TL_1 without waiting for all the tiles of the buffer circuit 250 to be filled. In other words, the buffer circuit 240 together with the buffer circuit 250 can achieve the same effect as a conventional ping-pong buffering.

### The Second Mode

Reference is made to FIG. 9, which is a flowchart of the DMA 222 operating in the second mode. The flowchart includes the following steps.
Step S905: The DMA 222 updates the variable i to i+1 and sets the variable j to 1. Continuing the example in FIG. 8, the DMA 222 updates the variable i to q+M in this step because, when the first mode ends, the variable i is equal to q+M−1. That is to say, when step S905 ends, i=1 (e.g., the image processing device 200 has just started processing a frame), or continue the value of the variable i in the first mode. The same applies to step S505.
Step S910: The DMA 222 determines whether the variable j is equal to M. If YES (i.e., the DMA 222 is processing the M^{th} buffer block LS_M), then the flow proceeds to step S940; otherwise, the flow proceeds to step S920.
Step S920: The DMA 222 writes the ((W*N)*(j−1)+1)^{th} to the ((W*N)*j)^{th} pixels (a total of W*N pixels) from a pixel line LN_i into a buffer block LS_j of the buffer circuit 240, more specifically, into the temporary space of the buffer block LS_j.
Step S930: The DMA 222 updates the variable j to j+1.
Step S940: The DMA 222 writes the remaining pixels from the pixel line LN_i into a buffer block LS_M of the buffer circuit 240. In some embodiments, the number of remaining pixels is exactly W*N. The end of step S940 indicates that the DMA 222 has written the pixel line LN_i into the buffer circuit 240. Since the pixel line LN_i is written into M buffer blocks, the DMA 222 performs a scatter write operation in the second mode. The write stride of scatter write is a buffer block (i.e., W*M*N pixels).
Step S950: The DMA 222 determines whether the variable i is an integer multiple of M (i.e., determines whether “i mod M” is equal to 0, where “mod” represents the modulo operation). If YES (meaning that the image processing circuit 220 has written another M pixel lines LN_q+M to LN_q+2M−1 into the temporary spaces of the buffer circuit 240, that is, each of the buffer blocks LS_1 to LS_M contains a portion of these M pixel lines), the flow proceeds to step S960 (end the second mode); otherwise, the flow proceeds to step S905 (execute the next round).
Step S960: The DMA 222 waits for an instruction from the processor 210. More specifically, the DMA 222 operates in a wait state (in which the operation is suspended) until the processor 210 controls it to exit the wait state and operate in the first mode (FIG. 5).

It should be noted that, in some cases, when the DMA 222 is operating in the second mode, the DMA 260 is operating in the first mode. In other words, while the DMA 260 reads the image data from the buffer circuit 240 to create more temporary spaces (step S710), the DMA 222 writes the image data into these temporary spaces of the buffer circuit 240 (step S920 or step S940).

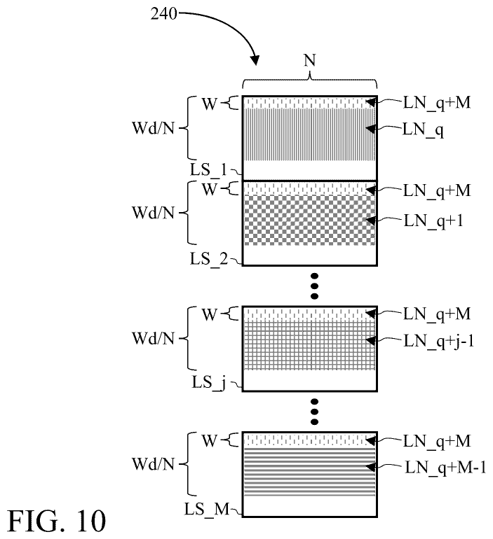

Reference is made to FIG. 10, which is a schematic diagram of the buffer circuit 240 after the DMA 222 has completed one round of the process in FIG. 9 according to the present invention. FIG. 10 is a continuation of the example in FIG. 8. As shown in the figure, the DMA 222 writes the (q+M)^{th} pixel line LN_q+M into the buffer blocks LS_i to LS_M. In the second mode, the write stride of the DMA 222 is the size of a buffer block (i.e., W*M*N pixels).

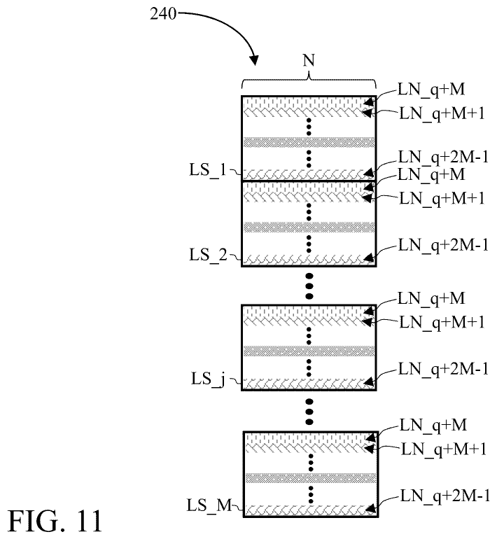

Reference is made to FIG. 11, which is a schematic diagram of the buffer circuit 240 after the DMA 222 has completed the process of FIG. 9 (the result of step S950 is YES) according to the present invention. As shown in the figure, the buffer blocks LS_1 to LS_M each store a portion of M pixel lines (LN_q+M)^{th} to (LN_q+2M−1)^{th}.

Reference is made to FIG. 12, which is a flowchart of the DMA 260 operating in the second mode. The flowchart includes the following steps.
Step S1205: The DMA 260 sets the variables j, k, and p all to 1.
Step S1210: The DMA 260 reads N pixels from the p^{th} row of the buffer block LS_j.
Step S1220: The DMA 260 writes the N pixels into the (┌p/W┐)^{th} row of the tile TL_k.
Step S1230: The DMA 260 determines whether ┌p/W┐ is equal to M. If YES (meaning that the DMA 260 has filled the tile TL_k), then the flow proceeds to step S1250; otherwise, the flow proceeds to step S1240.
Step S1240: The DMA 260 updates the variable p to p+W. In other words, the read offset of the DMA 260 is W*N pixels.
Step S1250: The DMA 260 determines whether the variable k is equal to W. If YES (meaning that the DMA 260 has finished reading an entire buffer block LS_j and has filled the buffer circuit 250), then the flow proceeds to step S1270; otherwise, the flow proceeds to step S1260.
Step S1260: The DMA 260 updates the variable k to k+1 and the variable p to k, and then the flow proceeds to step S1210.
Step S1270: The DMA 260 determines whether the variable j is equal to M. If YES (meaning that the DMA 260 has read all the buffer blocks (LS_1 to LS_M) of the buffer circuit 240), then the flow proceeds to step S1290; otherwise, the flow proceeds to step S1280.
Step S1280: The DMA 260 updates the variable j to j+1 and resets the variable k and the variable p to 1, and then the flow proceeds to step S1210.
Step S1290: The DMA 260 waits for an instruction from the processor 210. More specifically, the DMA 260 operates in a wait state (in which the operation is suspended) until the processor 210 controls it to exit the wait state and operate in the first mode (FIG. 7).

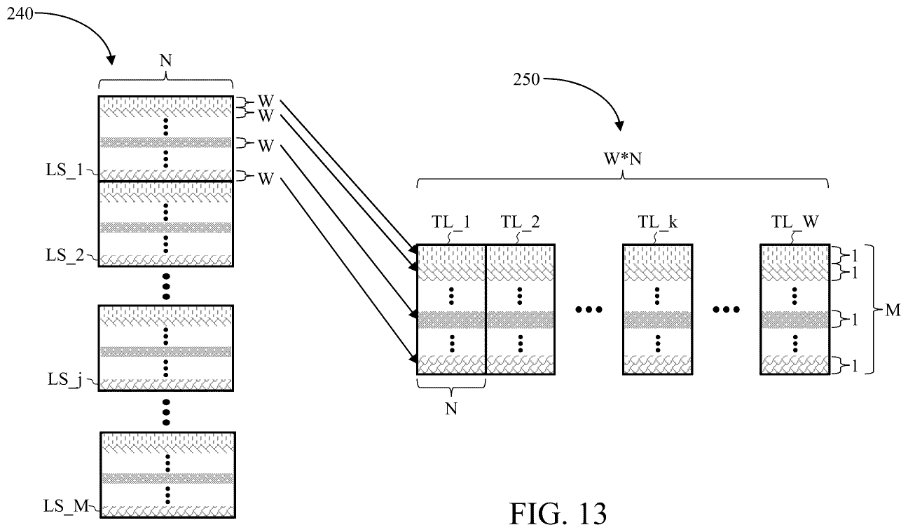

Reference is made to FIG. 13, which is a schematic diagram of the contents of the buffer circuit 240 and the buffer circuit 250 when the DMA 260 operates in the second mode according to the present invention. FIG. 13 shows that the DMA 260 has written M*W*N image data from the buffer block LS_1 into the buffer circuit 250. The DMA 260 starts writing the next tile (k=k+1 or k=1) only after it fills a tile (i.e., the result of step S1230 is YES). Therefore, the write stride of the DMA 260 is a row of the buffer circuit 250 (W*N pixels). It should be noted that when the DMA 260 has filled the tile TL_1, the DMA 232 can start reading the buffer circuit 250.

Reference is made to FIG. 13. When the image data in the buffer block LS_1 is completely written into the buffer circuit 250, the processor 210 controls the DMA 222 to switch to the first mode to execute the flow of FIG. 5 again (the first mode).

It should be noted that, in some cases, when the DMA 222 is operating in the first mode, the DMA 260 is operating in the second mode. In other words, while the DMA 260 reads the image data from the buffer circuit 240 to release more buffer blocks (step S1210), the DMA 222 writes the image data into the released buffer blocks (step S510).

The following provides examples for the first mode and the second mode regarding the piece of current access progress information CP1, the piece of current access progress information CP2, the first condition, and the second condition.

For the first mode, the piece of current access progress information CP1 may be the variable j of the DMA 222, and the first condition may be j=M. For example, reference is made to FIG. 6. When the DMA 222 has sequentially written the first to the (M−1)^{th} pixel lines from the consecutive M pixel lines of the frame 100 into the (M−1) buffer blocks of the buffer circuit 240 (e.g., the buffer block LS_1 to the buffer block LS_M−1 (not shown)) and has written the M^{th} pixel line into the remaining one of the M buffer blocks (e.g., the buffer block LS_M), the processor 210 controls the DMA 260 to exit the wait state and enter the first mode (i.e., continue the operation to execute the process of FIG. 7). The piece of current access progress information CP2 may be the variable k of the DMA 260, and the second condition may be k=W. For example, reference is made to FIG. 8. When the DMA 260 has read W*N pixels from each of the M buffer blocks (LS_1 to LS_M) (equivalent to when the DMA 260 has filled the buffer circuit 250, that is, when k=W), the processor 210 controls the DMA 222 to exit the wait state and enter the second mode (i.e., continue the operation to execute the process of FIG. 9).

For the second mode, the piece of current access progress information CP1 may be the variables i and j of the DMA 222, and the first condition may be i=c*M and j=1 (c=2, 4, 6, . . . ). For example, reference is made to FIG. 11. When the DMA 222 writes part of the data (W*N pixels) from the (q+2M−1)^{th} pixel line LN_q+2M−1 (q=r*M+1, r=0, 2, 4, 6, . . . ) into the buffer block LS_1, the processor 210 controls the DMA 260 to exit the wait state and enter the second mode (i.e., continue the operation to execute the process of FIG. 12). The piece of current access progress information CP2 may be the variable j and the variable p of the DMA 260, and the second condition may be j=1 and p=R. For example, reference is made to FIG. 13. When the DMA 260 has read all M*W*N pixels from the buffer block LS_1, the processor 210 controls the DMA 222 to exit the wait state and enter the first mode (i.e., continue the operation to execute the process of FIG. 5).

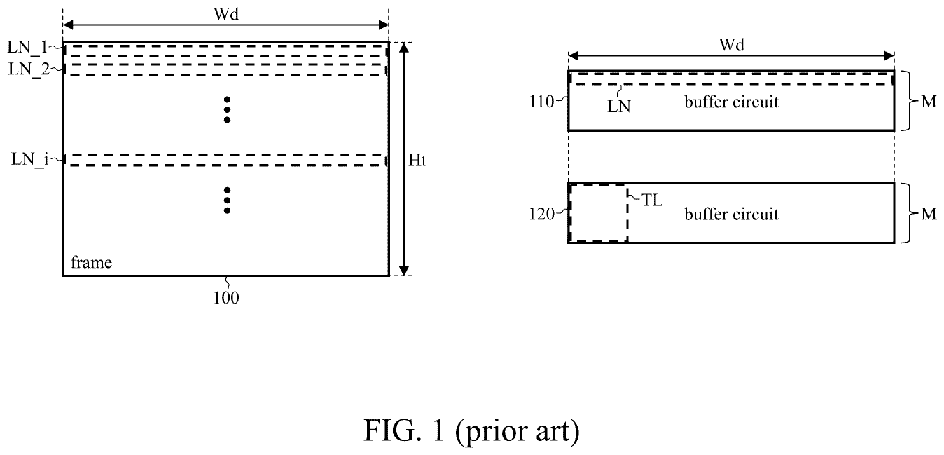

Reference is made to FIG. 1. The total size of the buffer circuit 110 and the buffer circuit 120 is Wd*M*2 pixels. Reference is made to FIG. 3. The total size of the buffer circuit 240 and the buffer circuit 250 of the present invention is (W*M*N)*M+W*M*N=(W*M*N)*(M+1) pixels. When W*M*N=Wd (i.e., the size of a buffer block LS_j is exactly equal to Wd pixels in a pixel line), the total size of the buffer circuit 240 and the buffer circuit 250 is (M+1)*Wd. In other words, the size of the buffer circuit of the present invention is approximately half the size of a conventional buffer circuit ((M+1)/2M); therefore the cost can be significantly reduced.

In some embodiments, whether in the first mode or the second mode, the operating speed of the DMA 260 is greater than or equal to the operating speed of the DMA 222, and the operating speed of the DMA 232 is greater than the operating speed of the DMA 260. This can be achieved by designing the clock of the image processing circuit 230 to be greater than the clock of the image processing circuit 220.

The operation of the conversion from line-based write to tile-based read is intended to illustrate the invention by way of example and not to limit the scope of the claimed invention. People having ordinary skill in the art may apply the present invention to the operation of the conversion from tile-based write to line-based read in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image processing device configured to process a frame, comprising:
a first buffer circuit comprising M buffer blocks, where M is an integer greater than one;
a second buffer circuit comprising W tiles, where W is an integer greater than one;
a first direct memory access (DMA) circuit coupled to the first buffer circuit and operating in a first mode or a second mode; and
a second DMA circuit coupled to the first buffer circuit and the second buffer circuit and operating in the first mode or the second mode;
wherein in the first mode, the first DMA circuit writes a first pixel line of the frame into one of the M buffer blocks, and the second DMA circuit reads N pixels from each of the M buffer blocks and writes the M*N pixels into one of the W tiles, where N is an integer greater than one;
wherein in the second mode, the first DMA circuit writes a second pixel line of the frame into the M buffer blocks, with each buffer block containing a portion of the second pixel line, and the second DMA circuit reads M*N pixels from one of the M buffer blocks and writes the M*N pixels into one of the W tiles;
wherein after the first DMA circuit writes M pixel lines into the M buffer blocks, the first DMA circuit switches modes.

2. The image processing device of claim 1, wherein the size of any one of the M buffer blocks is W*M*N pixels, and the size of each tile is N*M pixels.

3. The image processing device of claim 2, wherein M is equal to N.

4. The image processing device of claim 1, wherein the second DMA circuit switches modes after the second DMA circuit finishes reading the M buffer blocks.

5. The image processing device of claim 1, wherein the portion of the second pixel line is W*N pixels.

6. The image processing device of claim 1, wherein in the first mode, a write stride of the first DMA circuit is the size of a buffer block.

7. The image processing device of claim 1, wherein in the second mode, a write stride of the first DMA circuit is the size of a buffer block.

8. The image processing device of claim 1, wherein in the first mode, a read offset and a write stride of the second DMA circuit are respectively the size of a buffer block and a row of the second buffer circuit.

9. The image processing device of claim 1, wherein in the second mode, a read offset and a write stride of the second DMA circuit are respectively W*N pixels and a row of the second buffer circuit.

10. The image processing device of claim 1, wherein the first DMA circuit operates in a wait state before switching modes, and the image processing device further comprises:
a processor coupled to the first DMA circuit and the second DMA circuit and configured to receive a piece of current access progress information from the second DMA circuit and perform following steps:
controlling the first DMA circuit to exit the wait state and operate in the second mode when the piece of current access progress information meets a condition;
wherein the condition is that the second DMA circuit has read W*N pixels from each of the M buffer blocks.

11. The image processing device of claim 1, wherein the first DMA circuit operates in a wait state before switching modes, and the image processing device further comprises:
a processor coupled to the first DMA circuit and the second DMA circuit and configured to receive a piece of current access progress information from the second DMA circuit and perform following steps:
controlling the first DMA circuit to exit the wait state and operate in the first mode when the piece of current access progress information meets a condition;
wherein the condition is that the second DMA circuit has read M*W*N pixels from one of the M buffer blocks.

12. The image processing device of claim 1, wherein the second DMA circuit operates in a wait state before switching modes, and the image processing device further comprises:
a processor coupled to the first DMA circuit and the second DMA circuit and configured to receive a piece of current access progress information from the first DMA circuit and perform following steps:
controlling the second DMA circuit to exit the wait state and operate in the first mode when the piece of current access progress information meets a condition;
wherein the condition is that the first DMA circuit has written the first to the (M−1)^{th} pixel lines from the M pixel lines of the frame into (M−1) buffer blocks of the M buffer blocks and has written the portion of the M^{th} pixel line from the M pixel lines into a remaining one of the M buffer blocks.

13. The image processing device of claim 1, wherein the second DMA circuit operates in a wait state before switching modes, and the image processing device further comprises:
a processor coupled to the first DMA circuit and the second DMA circuit and configured to receive a piece of current access progress information from the first DMA circuit and perform following steps:
controlling the second DMA circuit to exit the wait state and operate in the second mode when the piece of current access progress information meets a condition;
wherein the condition is that the first DMA circuit has written the portion of the (c*M)^{th} pixel line of the frame into one of the M buffer blocks, where c is an even number.

14. The image processing device of claim 1, wherein an operating speed of the second DMA circuit is greater than an operating speed of the first DMA circuit.

15. The image processing device of claim 1, wherein when the first DMA circuit is operating in the first mode, the second DMA circuit is operating in the second mode, and when the first DMA circuit is operating in the second mode, the second DMA circuit is operating in the first mode.

16. A control method of an image processing device, wherein the image processing device is configured to process a frame and comprises a first buffer circuit, a second buffer circuit, a first direct memory access (DMA) circuit, and a second DMA circuit, the first buffer circuit comprises M buffer blocks, M is an integer greater than one, the second buffer circuit comprises W tiles, W is an integer greater than one, the first DMA circuit operates in a first mode or a second mode and generates a first piece of current access progress information, the second DMA circuit operates in the first mode or the second mode and generates a second piece of current access progress information, and the control method comprises:
controlling the second DMA circuit to switch modes when the first piece of current access progress information meets a first condition; or
controlling the first DMA circuit to switch modes when the second piece of current access progress information meets a second condition;
wherein in the first mode, the first DMA circuit writes a first pixel line of the frame into one of the M buffer blocks, and the second DMA circuit reads N pixels from each of the M buffer blocks and writes the M*N pixels into one of the W tiles, where N is an integer greater than one;
wherein in the second mode, the first DMA circuit writes a second pixel line of the frame into the M buffer blocks, with each buffer block containing a portion of the second pixel line, and the second DMA circuit reads M*N pixels from one of the M buffer blocks and writes the M*N pixels into one of the W tiles.

17. The control method of claim 16, wherein the first condition is that the first DMA circuit has written the first to the (M−1)^{th} pixel lines from M pixel lines of the frame into (M−1) buffer blocks of the M buffer blocks and has written the portion of the M^{th} pixel line from the M pixel lines into a remaining one of the M buffer blocks, and when the first piece of current access progress information meets the first condition, the second DMA circuit starts operating in the first mode.

18. The control method of claim 16, wherein the first condition is that the first DMA circuit has written the portion of the (c*M)^{th} pixel line of the frame into one of the M buffer blocks, c is an even number, and when the first piece of current access progress information meets the first condition, the second DMA circuit starts operating in the second mode.

19. The control method of claim 16, wherein the second condition is that the second DMA circuit has read W*N pixels from each of the M buffer blocks, and when the second piece of current access progress information meets the second condition, the first DMA circuit starts operating in the second mode.

20. The control method of claim 16, wherein the second condition is that the second DMA circuit has read M*W*N pixels from one of the M buffer blocks, and when the second piece of current access progress information meets the second condition, the first DMA circuit begins to operate in the first mode.
